(19) United States
(12) Patent Application Publication
(10) Pub. No.: US 2022/0203386 A1
(43) Pub. Date: Jun. 30, 2022

(54) CONNECTION STRUCTURE AND SPRAY SHOWER

(71) Applicant: JOMOO KITCHEN&BATH CO., LTD., Fujian (CN)

(72) Inventors: Xiaofa LIN, Fujian (CN); Xiaoshan LIN, Fujian (CN); Guangwei MAO, Fujian (CN)

(73) Assignee: JOMOO KITCHEN&BATH CO., LTD., Fujian (CN)

(21) Appl. No.: 17/499,888

(22) Filed: Oct. 13, 2021

(30) Foreign Application Priority Data
Dec. 30, 2020 (CN) 202023328527.7

(51) Int. Cl. B05B 1/18

(52) U.S. Cl. CPC B05B 1/185

(57) ABSTRACT

The disclosure discloses a connection structure and a spray shower. A connection structure includes a first object, a buckle and a second object. The first object includes a connection channel and a sliding slot perpendicular to the connection channel. A retaining wall and a plug-in channel are provided between the sliding slot and the connection channel. An insertion buckle is provided with a buckle body slidable in the sliding slot and an insertion piece adapted to be inserted in or retracted from the connection channel through the plug-in channel. The second object is inserted into the connection channel and is provided with a recess matching the insertion piece. The spray shower includes the connection mechanism. The connection structure and the spray shower are mechanically connected.

### CROSS-REFERENCE TO RELATED APPLICATION

This application claims the priority benefit of China application serial no. 202023328527.7, filed on Dec. 30, 2020. The entirety of the above-mentioned patent application is hereby incorporated by reference herein and made a part of this specification.

### BACKGROUND

### Technical Field

The disclosure relates to the field of shower devices, in particular to a connection structure and a spray shower.

### Description of Related Art

In the related art, shower and the functional elements attached to the shower are generally connected by means of magnetic connection or mechanical connection. However, the shower and functional elements which are connected through magnetic connection methods tend to be easily disconnected when being subjected to an external force, while mechanical connection methods are often complicated in structure although such methods do not easily cause disconnection.

### SUMMARY

The following is an overview of the subject matter described in detail in this disclosure. This overview is not intended to limit the scope of protection of the claims.

A connection structure includes a first object, an insertion buckle and a second object. The first object includes a first end surface, a connection channel connected to the first end surface along a first direction, and a sliding slot connected to the first end surface along the second direction perpendicular to the first direction. Two side walls of the sliding slot are respectively provided with two ribs opposite to each other and extending along the second direction. The first object is provided with a retaining wall between the sliding slot and the connection channel. A plug-in channel connecting the sliding slot and the connection channel is provided on the retaining wall. The insertion buckle is provided with a buckle body, an insertion piece and elastic buckles that are integrally connected to each other. The buckle body is adapted to slide in the sliding slot along the second direction. The insertion piece is adapted to be inserted in or retracted from the connection channel by passing through the plug-in channel. The elastic buckles extend from the first surface of the buckle body along the first direction and are adapted to be engaged with the ribs. The first surface is the surface away from the first end surface when the buckle body is installed in the sliding slot. The second object is adapted to be inserted into the connection channel along the first direction, and is provided with a recess matching the insertion piece. The recess is provided in an outer wall that fits with the connection channel. By adopting the above connection structure, the user only needs to drive the insertion buckle to slide in the second direction to realize the connection or disconnection of the second object and the first object, so the operation is convenient and the structure is simple.

A spray shower includes the above-mentioned connection structure. The first object is a shower body, and the second object is a sprayer. The shower body is provided with a through hole along the first direction, and the through hole forms the connection channel. By adopting the spray shower with the above-mentioned connection structure, it is possible to easily attach the sprayer to the shower body, and the sprayer and the shower body are not easily separated during use.

### BRIEF DESCRIPTION OF THE DRAWINGS

In order to explain the technical solutions of the embodiments more clearly, the following briefly describes the drawings that need to be used.

FIG. 1 is a top view of a spray shower in an embodiment.

FIG. 2 is a perspective exploded view of the spray shower in the embodiment.

FIG. 3 is a cross-sectional view of the spray shower in the embodiment.

FIG. 4 is a cross-sectional view of the spray shower in the embodiment when a sprayer is not installed.

FIG. 5 is a perspective view of an annular upper cover in the embodiment.

FIG. 6 is a perspective view of an insertion buckle in the embodiment.

FIG. 7 is a cross-sectional view of the sprayer in the embodiment.

FIG. 8 is a schematic view of the installation or removal of the sprayer in the embodiment.

### DESCRIPTION OF THE EMBODIMENTS

In the claims and specification, unless otherwise defined, the term “connection channel” refers to a channel that allows the second object to be inserted along the first direction and does not allow the second object to exit in any direction perpendicular to the first direction.

The technical solutions in the embodiments of the disclosure will be described below with reference to the drawings in the embodiments of the disclosure.

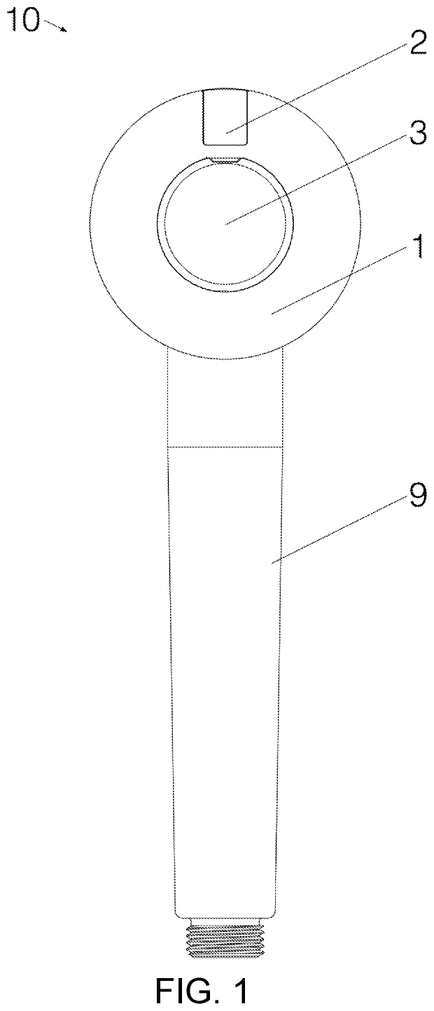

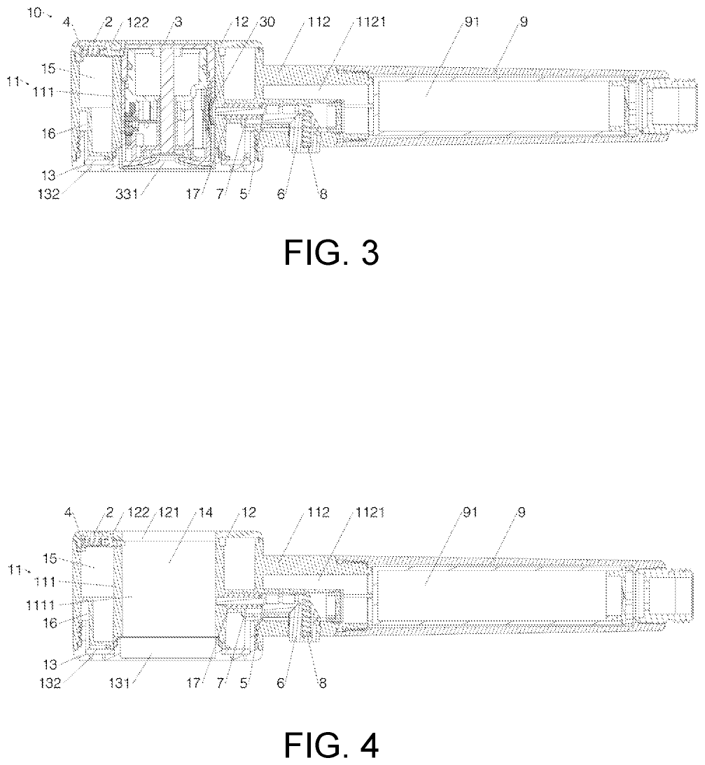

Referring to FIG. 1 to FIG. 3, FIG. 1 to FIG. 3 show a spray shower 10 in an embodiment. As shown in FIG. 1 to FIG. 3, the spray shower 10 includes a shower body 1, an insertion buckle 2, a sprayer 3, a first elastic member 4, a connection rod 5, a button 6, a second elastic member 7, a third elastic member 8 and a water inlet pipe 9.

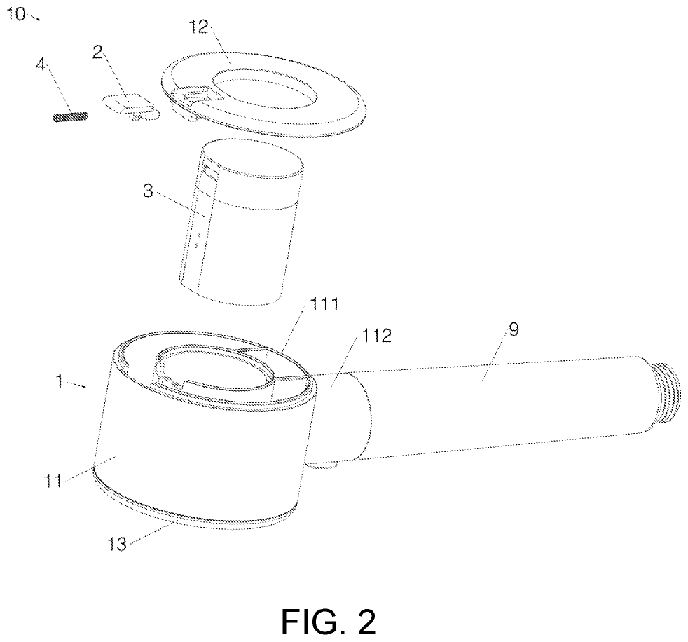

Specifically, the shower body 1 is shown in FIG. 2 and FIG. 4, and includes a main body 11, an annual upper cover 12 and an annual water outlet cover 13.

The main body 11 is provided with a water outlet portion 111 and a handle portion 112 which are integrally connected with each other. The water outlet portion 111 is provided with a central hole 1111 along the first direction. A partition wall is arranged in the middle of the water outlet portion 111, and the partition wall divides the water outlet portion 111 into two annular cavities with openings, which are a first annular open cavity that opens upwards and a second annular open cavity that opens downwards. The handle portion 112 extends from the side wall of the water outlet portion 111 in a second direction perpendicular to the first direction, and is provided with a water passage 1121 extending in the second direction, and the water passage 1121 communicates with the second annular open cavity. The main body 11 is further provided with a connection rod channel 17. Specifically, the connection rod channel 17 extends from a hole wall of the central hole 1111 to the handle portion 112 along the second direction, and is isolated from the water passage 1121 in the handle portion 112. The handle portion 112 is further provided with a pressing hole intersecting the connection rod channel 17. The central hole 1111 of the water outlet portion 111 is substantially a cylindrical hole, and has a hole wall surface facing the connection rod channel 17, and this hole wall surface is a planar surface, which is connected with the arc-shaped annular surface formed by other parts of the central hole 1111.

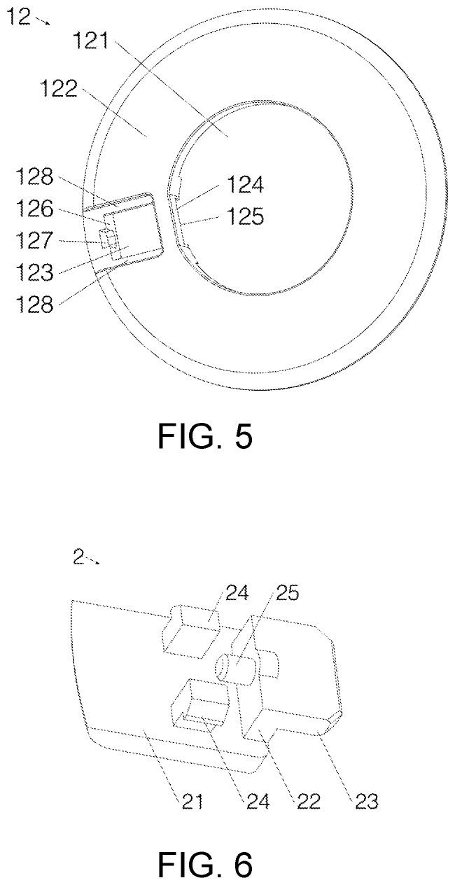

As shown in FIG. 4, the annular upper cover 12 is fixed to the water outlet portion 111 of the main body 11, and closes the opening of the first annular open cavity to form a mounting cavity 15, and the surface of the annular upper cover 12 away from the mounting cavity 15 forms a first end surface 122. As shown in FIG. 5, the annular upper cover 12 is provided with a center hole 121, and the section of the center hole 121 of the annular upper cover is exactly the same as the section of the central hole 1111 of the water outlet portion 111. The annular upper cover 12 is further provided with a sliding slot 123 along the second direction. The sliding slot 123 is connected to the first end surface 122 and penetrates along the first direction. The two side walls of the sliding slot 123 are respectively provided with two ribs 128 opposite to each other and both extending along the second direction. A retaining wall 124 is formed between the sliding slot 123 and the center hole 121, and a portion of the retaining wall 124 close to a lower surface of the annular upper cover 12 is provided with a plug-in channel 125 extending along the second direction. The annular upper cover 12 is further provided with an abutting wall 126 opposite to the retaining wall 124, and the sliding slot 123 is located between the retaining wall 124 and the abutting wall 126. A part of the sliding slot 123 located between the ribs 128 and the first end surface 122 extends along the second direction and opens on an outer peripheral surface of the annular upper cover 12. An upper surface of the abutting wall 126 is aligned with an upper surface of each of the ribs 128. The abutting wall 126 further defines a notch 127 toward the direction of the retaining wall 124, and the notch 127 opens on the upper surface of the abutting wall 126.

The annular water outlet cover 13 is fixedly connected to the water outlet portion 111 of the main body 11 as shown in FIG. 4, and closes the opening of the second annular open cavity to form a water outlet cavity 16. Because the second annular open cavity communicates with the water passage 1121, the water outlet cavity 16 also communicates with the water passage 1121. The annular water outlet cover 13 is provided with a central hole 131, and the section of the central hole 131 is exactly the same as the section of the central hole 1111 of the water outlet portion 111. The annular water outlet cover 13 is further provided with a plurality of water outlet holes 132 penetrating in the first direction and surrounding the central hole 131. The water outlet hole 132 communicates with the water outlet cavity 16, and a water outlet direction of the water outlet hole 132 is oriented downward along the first direction as shown in FIG. 4.

As shown in FIG. 4, after the annular upper cover 12 and the annular water outlet cover 13 are fixed to the main body 11, the center hole 121 of the annular upper cover 12, the central hole 1111 of the water outlet portion 111 and the central hole 131 of the annular water outlet cover 13 form a through hole 14 at the water outlet portion 111. The through hole 14 constitutes a connecting channel. The connection rod channel 17 is opened on the hole wall of the through hole 14, and the hole wall of the through hole 14 opposite to the connection rod channel 17 forms a continuous plane in up and down directions. The plug-in channel 125 of the annular upper cover 12 communicates with the through hole 14.

As shown in FIG. 6, the insertion buckle 2 is provided with a buckle body 21, a connection wall 22, an insertion piece 23, a protruding shaft 25 and two elastic buckles 24 which are integrally connected to each other as one piece. Specifically, the entire buckle body 21 has a sheet shape, and a width of the buckle body 21 matches a width of the sliding slot 123. One end of the buckle body 21 is arc-shaped to match the shape of the outer periphery of the annular upper cover 12, and the other end of the buckle body 21 is connected to the insertion piece 23 through the connection wall 22. Both the buckle body 21 and the insertion piece 23 extend along the second direction, and the connection wall 22 extends along the first direction. The surface of the connection wall 22 facing away from the insertion piece 23 is further provided with a protruding shaft 25 extending along the second direction. Two elastic buckles 24 extend along the first direction from the first surface of the buckle body 21. The hooks of the two elastic buckles 24 extend in directions away from each other, and are adapted for engaging with the two ribs 128 of the sliding slot 123, so that the insertion buckle 2 cannot be separated from the annular upper cover 12 along the first direction. Specifically, the first surface refers to the surface away from the first end surface 122 when the buckle body 21 is installed in the sliding slot 123. The insertion piece 23 is configured to be adapted to pass through a plug-in channel 125 of the annular upper cover 12. The length of the elastic buckle 24 along the second direction is configured in the manner that the insertion buckle 2 is adapted for sliding along the second direction in the sliding slot 123, so that the insertion piece 23 passes through the plug-in channel 125 of the annular upper cover 12 and inserts in or retracts from the through hole 14.

The first elastic member 4 is a spring, which is sleeved on the protruding shaft 25, and when the insertion buckle 2 is installed on the annular upper cover 12, the first elastic member 4 is placed between the notch 127 of the abutting wall 126 and the connection wall 22. As shown in FIG. 4, after the insertion buckle 2 and the first elastic member 4 are installed on the annular upper cover 12, the first elastic member 4 supports and abuts the insertion buckle 2 along the second direction, so that the insertion piece 23 is maintained in a state of passing through the plug-in channel 125 and inserting into the through hole 14. The user can also manipulate the insertion buckle 2 to overcome the elastic force of the first elastic member 4 and to slide relative to the sliding slot 123 in a direction away from the through hole 14. Under the circumstances, the first elastic member 4 compresses and stores energy, and the insertion piece 23 will retract from the through hole 14.

The connection rod 5 is slidably arranged in the connection rod channel 17, and one end of the connection rod 5 away from the through hole 14 forms a radial protrusion.

The button 6 is slidably disposed in the pressing hole, and is inclined to fit with the connection rod 5, and the button 6 is also fittingly coupled with the wall of the handle portion 112 of the main body 11, so that the button 6 cannot be separated from the handle portion 112.

The second elastic member 7 is a spring, which is sleeved outside the connection rod 5, one end of which abuts against the wall of the main body 11, and the other end thereof abuts against the radial protrusion of the connection rod 5.

The third elastic member 8 is a spring, one end of which abuts against the bottom wall of the pressing hole, and the other end thereof abuts against the button 6.

By pressing the button 6, the button 6 overcomes the elastic force of the third elastic member 8 to push the connection rod 5 to overcome the elastic force of the second elastic member 7, so as to move toward the through hole 14 along the second direction. When the button 6 is released, the second elastic member 7 is reset and drives the connection rod 5 to move away from the through hole 14 along the second direction. In the meantime, the connection rod 5 and the third elastic member 8 jointly drive the button 6 to reset.

As shown in FIG. 4, the water inlet pipe 9 is provided with an inlet waterway 91 extending in the second direction. The water inlet pipe 9 is threadedly connected with one end of the handle portion 112 away from the water outlet portion 111, so that the inlet waterway 91 communicates with the water passage 1121.

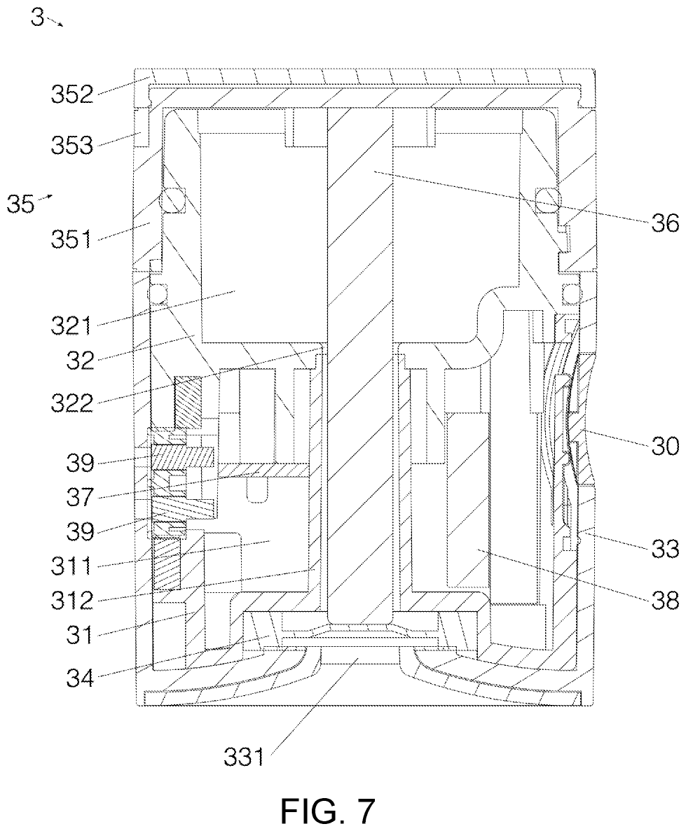

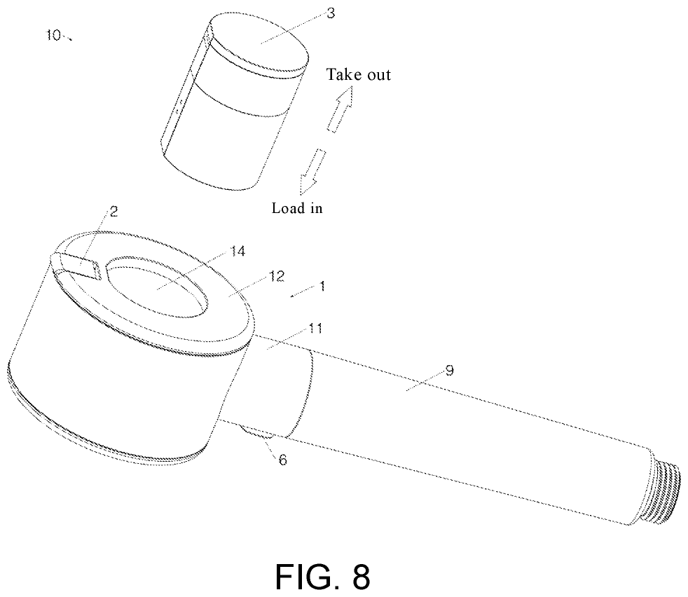

As shown in FIG. 7, the sprayer 3 includes a mounting base 31, a liquid storage cylinder 32, a housing 33, an atomizing sheet 34, a top cover 35, a siphon body 36, an electric control board 37, a battery 38, a charging electrode 39 and an enable switch 30. Specifically, the mounting base 31 is provided with an accommodating cavity 311 with an opening upward (in the direction shown in FIG. 7) and a tube body 312 extending in the accommodating cavity 311 along the first direction. The tube body 312 is hollow and has two ends open. The liquid storage cylinder 32 is provided with a liquid storage cavity 321 with an opening that is open upward. The liquid storage cylinder 32 is arranged on the upper end of the tube body 312 and is provided with a through hole 322 communicating with the tube body 312. The through hole 322 is sealed and matched with the tube body 312 so that the liquid in the liquid storage cylinder 32 cannot enter the accommodating cavity 311. The housing 33 is configured for accommodating the mounting base 31 and sleeves outside the liquid storage cylinder 32 in a sealed manner. The housing 33 is provided with a spray hole 331. The atomizing sheet 34 is sandwiched between the housing 33 and the mounting base 31, and faces the lower end of the tube body 312 and the spray hole 331, and is configured to generate atomized liquid droplets through ultrasonic vibration. The top cover 35 and the liquid storage cylinder 32 are detachably and hermetically connected. Specifically, the top cover 35 includes a cover body 351 and a decorative cover 352 fixedly installed on the cover body 351. The decorative cover 352 is provided with a notch. When the decorative cover 352 is placed on the cover body 351, the notch forms a recess 353. The recess 353 is configured to match the insertion piece 23 and is adapted for being inserted by the insertion piece 23. In this embodiment, the cover body 351 is detachably fixed to the liquid storage cylinder 32 through a snap rotation. The siphon body 36 in the embodiment adopts a PP cotton stick, one end of which abuts against or close to the lower surface of the cover body 351, and the other end thereof penetrates the through hole 322 and the tube body 312 and abuts against the atomizing sheet 34. The electric control board 37 is fixedly placed in the accommodating cavity 311 for driving the atomizing sheet 34 to vibrate. The battery 38 is fixedly placed in the accommodating cavity 311 for powering the electric control board 37. The charging electrode 39 is arranged on the side wall of the housing 33 and is configured to charge the battery 38. The enable switch 30 is arranged on the side wall of the housing 33, and the spray is turned on and off by controlling the electric control board 37. The side wall of the housing 33 and the side wall of the top cover 35 form the side wall of the sprayer 3. The side wall of the sprayer 3 is configured to be adapted for inserting into the through hole 14, and the part facing away from the enable switch 30 forms a planar surface matching with a surface of the hole wall of the through hole 14, so as to form a positioning structure with the hole wall of the through hole 14. As such, when the sprayer 3 is inserted into the through hole as shown in FIG. 8, the recess 353 can be aligned with the plug-in channel 125, and the enable switch 30 can be aligned with the connection rod channel 17.

As shown in FIG. 8, in this embodiment, when the user intends to install the sprayer 3 into the shower body 1, first the insertion buckle 2 should be manipulated to slide in the direction away from the through hole 14 along the second direction. At this time, the insertion piece 23 retracts from the through hole 14 so that the sprayer 3 can be inserted into the through hole 14. When the upper surface of the decorative cover 352 of the sprayer 3 is flush with the first end surface 122 of the annular upper cover 12, the recess 353 is aligned with the plug-in channel 125, so that the enable switch 30 is aligned with the connection rod channel 17, and the spraying direction of the spray hole 331 is the same as the water outlet hole 132, that is, facing downward in FIG. 8. Under the circumstances, the insertion buckle 2 is released, and the insertion buckle 2 slides toward the through hole 14 under the action of the first elastic member 4, so that the insertion piece 23 is inserted into the recess 353, and the sprayer 3 is connected to the shower body 1. The process of removing the sprayer3 from the shower body 1 is the opposite from what is described above, so no further description is incorporated herein.

If the user intends to drive the sprayer 3 to spray, only by pressing the button 6, the connection rod 5 extends out of the connection rod channel 17 to press the enable switch 30. The enable switch 30 controls the electric control board 37 to drive the atomizer plate 34 to vibrate, and the liquid in the liquid storage cavity 321 is delivered to the atomizing sheet 34 by the siphon body 36 and sprayed from the spray hole 331. If the user intends to stop spraying, only by releasing the button 6, the connection rod 5 retracts into the connection rod channel 17, the enable switch 30 is released, and the spray hole 331 stops spraying.

With the connection structure in this embodiment, the sprayer 3 and the shower body 1 can be connected and disconnected only by driving the insertion buckle 2 to slide in the second direction, and therefore the operation is easy. In this embodiment, only an easy-to-manufacture insertion buckle 2 and the first elastic member 4 are added, and therefore the structure is simple.

In this embodiment, the sliding slot 123 is connected to the first end surface 122, so that the insertion buckle 2 can be easily mounted into the sliding slot 123 from the first end surface 122. In this embodiment, the elastic buckles 24 are respectively engaged with the ribs 128 so that the insertion buckle 2 cannot be easily detached from the shower body in the first direction.

In this embodiment, the first elastic member 4 abuts against the buckle 2, so that the insertion piece 23 remains in the state of inserting into the through hole 14, so that the shower body 1 and the sprayer 3 are connected more firmly.

In this embodiment, the annular upper cover 12 and the main body 11 are enclosed to form the mounting cavity 15, which can make way for the snap fit between the elastic buckles 24 and the ribs 128, so that the insertion buckle 2 has a space to move in the first direction. In this embodiment, the connection wall 22 of the insertion buckle 2 is provided with a protruding shaft 25, so that the first elastic member 4 can be easily installed in the sliding slot 123 together with the insertion buckle 2.

In this embodiment, the button 6 is inclined to match with the connection rod 5, so that the button 6 can drive the enable switch 30 through the connection rod 5, so that the user can operate the sprayer 3 with one hand.

In this embodiment, the side wall of the sprayer 3 and the hole wall of the through hole 14 form a positioning structure, which facilitates the user to easily align the enable switch 30 with the connection rod channel 17.

In this embodiment, the liquid is added through the detachable configuration of the top cover 35 and the liquid storage cylinder 32, and the user can add liquid into the liquid storage cavity 321 in a shorter time, and guide the liquid to the atomizing sheet 34 through the siphon body 36, so that the atomization effect is not affected even when the amount of liquid is little.

The connection structure of the shower body 1 and the sprayer 3 in this embodiment is not limited to this embodiment itself, and can also be applied to any two objects that are inserted and fitted through a connection channel (the through hole 14 in this embodiment).

The descriptions in the foregoing specification and embodiments are used to explain the protection scope of the present disclosure, but do not constitute a limitation to the protection scope of the present disclosure.

What is claimed is:

1. A connection structure, comprising:
a first object, including a first end surface, a connection channel connected to the first end surface along a first direction, and a sliding slot connected to the first end surface along a second direction perpendicular to the first direction, wherein two side walls of the sliding slot are respectively provided with two ribs opposite to each other and extending along the second direction; the first object is provided with a retaining wall between the sliding slot and the connection channel; a plug-in channel connecting the sliding slot and the connection channel is provided on the retaining wall;
an insertion buckle, including a buckle body, an insertion piece and elastic buckles that are integrally connected to each other; wherein the buckle body is adapted to slide in the sliding slot along the second direction, the insertion piece is adapted to be inserted in or retracted from the connection channel by passing through the plug-in channel, the elastic buckles extend from a first surface of the buckle body along the first direction and are adapted to be engaged with the ribs, the first surface is the surface away from the first end surface when the buckle body is installed in the sliding slot; and
a second object, adapted to be inserted into the connection channel along the first direction, wherein the second object is provided with a recess matching the insertion piece, and the recess is provided in an outer wall that fits with the connection channel.

2. The connection structure according to claim 1, further comprising a first elastic member, wherein the first elastic member is placed between the first object and the insertion buckle, and supports and abuts the insertion buckle along the second direction, such that the insertion piece remains in a state of reaching into the connection channel.

3. A spray shower, comprising the connection structure according to claim 2, wherein the first object is a shower body, and the second object is a sprayer; the shower body is provided with a through hole along the first direction, and the through hole forms the connection channel.

4. The spray shower according to claim 3, wherein the shower body comprises a main body, an annular upper cover, and an annular water outlet cover; the main body is provided with a water outlet portion and a handle portion integrally connected to each other, the through hole is provided on the water outlet portion, and the annular upper cover and the annular water outlet cover are respectively fixed to two ends of the water outlet portion along a first direction;
a surface of the annular upper cover away from the annular water outlet cover forms the first end surface; the annular water outlet cover is provided with a plurality of water outlet holes; the water outlet portion and the annular upper cover form amounting cavity, and the water outlet portion and the annular water outlet cover form a water outlet cavity isolated from the mounting cavity; and the handle portion is provided with a water passage communicating with the water outlet cavity.

5. The spray shower according to claim 4, wherein the sliding slot is provided on the annular upper cover; a part of the sliding slot between the ribs and the first end surface is opened on an outer peripheral surface of the annular upper cover; the annular upper cover is further provided with an abutting wall opposite to the retaining wall, the sliding slot is arranged between the abutting wall and the retaining wall; the insertion buckle is provided with a connection wall connecting the buckle body and the insertion piece; the connection wall is provided with a protruding shaft extending toward the abutting wall; the first elastic member is sleeved on the protruding shaft and is placed between the connection wall and the abutting wall.

6. The spray shower according to claim 5, further comprising a connection rod, a button and a second elastic member; wherein the shower body is provided with a connection rod channel; the connection rod channel extends from a hole wall of the through hole to a handle portion and is isolated from the water passage; the handle portion is provided with a pressing hole intersecting the connection rod channel; the connection rod is slidably arranged in the connection rod channel; the button is slidably arranged in the pressing hole and is inclined to fit with the connection rod; the sprayer is provided with a spray hole for spraying and an enable switch for turning on or off the spray; when the sprayer is installed in the through hole, the spray hole faces a same direction as the water outlet hole, and the enable switch faces the connection rod channel; the second elastic member is placed between the main body and the connection rod, and when the button is released, the connection rod is driven to reset to turn off the enable switch.

7. The spray shower according to claim 6,wherein a positioning structure is formed between a side wall of the sprayer and the hole wall of the through hole, so that when the sprayer is inserted into the through hole, the recess is aligned with the plug-in channel and the enable switch is aligned with the connection rod channel.

8. The spray shower according to claim 7, wherein the sprayer further comprises a mounting base, a liquid storage cylinder, a housing, an atomizing sheet, a top cover, a siphon body, an electric control board, a battery, and a charging electrode;
the mounting base is provided with an accommodating cavity and a tube body extending in the accommodating cavity along the first direction; the liquid storage cylinder is provided with a liquid storage cavity and is located at a first end of the tube body and provided with a through hole communicating with the tube body; the housing is configured for accommodating the mounting base and sleeves outside the liquid storage cylinder in a sealed manner, the spray hole is provided on the housing; the atomizing sheet is sandwiched between the housing and the mounting base, and faces a second end of the tube body and the spray hole; the top cover is detachably and hermetically connected with the liquid storage cylinder; one end of the siphon body abuts against or close to the top cover, and the other end of the siphon body penetrates the through hole of the liquid storage cylinder and the tube body, and abuts against the atomizing sheet; the electric control board is placed in the accommodating cavity for driving the atomizing sheet to vibrate; the battery is placed in the accommodating cavity for powering the electric control board; the charging electrode is arranged at a side wall of the housing and is configured to charge the battery; the enable switch is arranged on the side wall of the housing, and turns on or off the sprayer by controlling the electric control board.

9. The spray shower according to claim 4, further comprising a water inlet pipe, wherein the water inlet pipe is detachably fixed to the handle portion; the water inlet pipe is provided with an inlet waterway communicating with the water passage.
